(19) United States
(12) Patent Application Publication
(10) Pub. No.: US 2005/0282045 A1
(43) Pub. Date: Dec. 22, 2005

(54) Magnetic recording medium and magnetic recording/reproducing apparatus using the same

(75) Inventor: Koji Sonoda, Ome-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/151,451

(22) Filed: Jun. 14, 2005

(30) Foreign Application Priority Data
Jun. 22, 2004 (JP) 2004-183932

(51) Int. Cl. G11B 5/65

(52) U.S. Cl. 428/843.5

(57) ABSTRACT

A magnetic recording medium including a lubricating layer formed by using a lubricant containing first perfluoropolyether having one or more CH₃ groups or one or more CF₃ groups at two ends, and second perfluoropolyether having a polar group at least at one end.

### CROSS-REFERENCE TO RELATED APPLICATIONS

This application is based upon and claims the benefit of priority from prior Japanese Patent Application No. 2004-183932, filed Jun. 22, 2004, the entire contents of which are incorporated herein by reference.

### BACKGROUND OF THE INVENTION

1. Field of the Invention

The present invention relates to a magnetic recording medium used in, e.g., a hard disk drive using the magnetic recording technique and, more particularly, to a magnetic recording medium having an improved lubricating layer.

2. Description of the Related Art

A magnetic recording medium has a lubricating layer which suppresses wear by interposing between a head slider and the medium surface when the head slider slides. A lubricant used in this lubricating layer is required to have conflicting characteristics, i.e., required to fix to the medium surface and not to adhere to the head slider.

In a recent thin-film magnetic recording medium, a surface protective layer is formed on the surface of the medium. If the thickness of the lubricating layer is 1 nm or less, the layer forms islands and is unable to cover the whole surface protective layer. Therefore, the thickness of the lubricating layer is usually about 2 nm. In a magnetic recording medium like this, a lubricant such as perfluoropolyether having an active group at the end is applied, and bonded to the surface protective layer by annealing. However, if the end group is bonded, a characteristic self-repair function of a liquid deteriorates, and a semisolid-like lubricating layer wears the medium surface. To prevent this, a 1-nm thick lower layer of the lubricating layer is bonded to the medium surface to form a bond layer, and an upper layer is given flowability to form a mobile layer.

For example, it is possible to suppress deterioration of the lubricating characteristics and increase the sliding resistance by coating a magnetic disk with a new lubricant ZDPA having a dialkylamine end group which passivates Lewis acid which presumably accelerates a decomposition reaction of a lubricant (e.g., “Tribology Letters” February 2002, Vol. 12, No. 2, p. 117).

The new lubricant ZDPA of this prior art surely has a high decomposition resistance, but does not have any polar group. Therefore, the interaction with the protective layer is weak, so the amount of bond layer is very small. As a consequence, the lubricating layer is easily pushed aside in a sliding portion, and the surface of the protective layer is exposed. This causes solid contact between the head and protective layer, and decreases the sliding resistance of the medium. Although this inconvenience can be avoided by increasing the thickness of the lubricating layer, the amount of mobile layer excessively increases while the amount of bond layer does not, and this increases the frictional force. It is also possible to increase the amount of bond layer by giving it a polar group. However, this deteriorates the self-repair properties and decreases the sliding resistance. Especially in a low-temperature environment, the viscosity of the lubricating layer readily lowers, so the decrease in sliding resistance is significant.

### BRIEF SUMMARY OF THE INVENTION

A magnetic recording medium of the present invention is characterized by comprising
a nonmagnetic substrate,
a magnetic recording layer formed on the nonmagnetic substrate,
a protective layer formed on the magnetic recording layer, and
a lubricating layer formed on the protective layer by using a lubricant containing first perfluoropolyether having one or more CH₃ groups or one or more CF₃ groups at two ends, and second perfluoropolyether having a polar group at least at one end,
wherein the lubricating layer has a bond layer which contains most of the second perfluoropolyether and is bonded to a surface of the protective layer, and a mobile layer which is formed on the bond layer, contains most of the first perfluoropolyether, and has flowability.

A magnetic recording/reproducing apparatus of the present invention is characterized by comprising
a magnetic recording medium comprising
a nonmagnetic substrate,
a magnetic recording layer formed on the nonmagnetic substrate,
a protective layer formed on the magnetic recording layer, and
a lubricating layer formed on the protective layer by using a lubricant containing first perfluoropolyether having one or more CH₃ groups or one or more CF₃ groups at two ends, and second perfluoropolyether having a polar group at least at one end,
the lubricating layer having a bond layer which contains most of the second perfluoropolyether and is bonded to a surface of the protective layer, and a mobile layer which is formed on the bond layer, contains most of the first perfluoropolyether, and has flowability, and
a recording/reproducing head.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a sectional view showing an example of a magnetic recording medium according to the present invention;

FIG. 2 is a model view of a lubricating layer used in the present invention;

FIG. 3 is a schematic view showing an example of a magnetic recording/reproducing apparatus according to the present invention; and

FIG. 4 is a sectional view showing another example of the magnetic recording medium according to the present invention.

### DETAILED DESCRIPTION OF THE INVENTION

A magnetic recording medium of the present invention comprises a nonmagnetic substrate, a magnetic recording layer formed on the nonmagnetic substrate, a protective layer formed on the magnetic recording layer, and a lubricating layer formed on the protective layer and having a bond layer bonded to the surface of the protective layer, and a mobile layer formed on the bond layer and having flowability.

A magnetic recording/reproducing apparatus of the present invention has the magnetic recording medium described above, and a recording/reproducing head.

In some embodiment, this recording/reproducing head can be an extremely low floating type head or a contact type head.

The lubricating layer used in he present invention is formed by using at least two types of perfluoropolyethers. One is first perfluoropolyether having one or more methyl (CH₃) groups or one or more fluorocarbon (CF₃) groups at the two ends. The other is second perfluoropolyether having a polar group at least at one end.

The lubricating layer can be formed by coating the protective layer with a coating solution containing the above two types of perfluoropolyethers and an appropriate solvent, and heating the coating film.

Alternatively, the lubricating layer can be formed by applying the second perfluoropolyether, heating it, washing away the lubricant not bonded to the protective layer, and applying the first perfluoropolyether.

The formed lubricating layer is substantially made up of a bond layer bonded to the protective layer by heating, having a polar group at least at one end, and mainly containing the second perfluoropolyether, and a mobile layer present on the bond layer, mainly containing the first perfluoropolyether which has one or more CH₃ groups or one or more CF₃ groups at the two ends, and having flowability.

When the present invention is used, it is possible to improve the repair properties of the lubricating layer of the magnetic recording medium and the sliding characteristics which depend on the repair properties for long time periods, and to provide a magnetic recording/reproducing apparatus which uses this magnetic recording medium and has high reliability even when an extremely low floating type head or a contact type head is mounted.

FIG. 1 is a sectional view showing an example of the magnetic recording medium according to the present invention.

As shown in FIG. 1, a magnetic recording medium 10 has a structure in which a magnetic recording layer 2, protective layer 3, and lubricating layer 4 are formed in order on a nonmagnetic substrate 1.

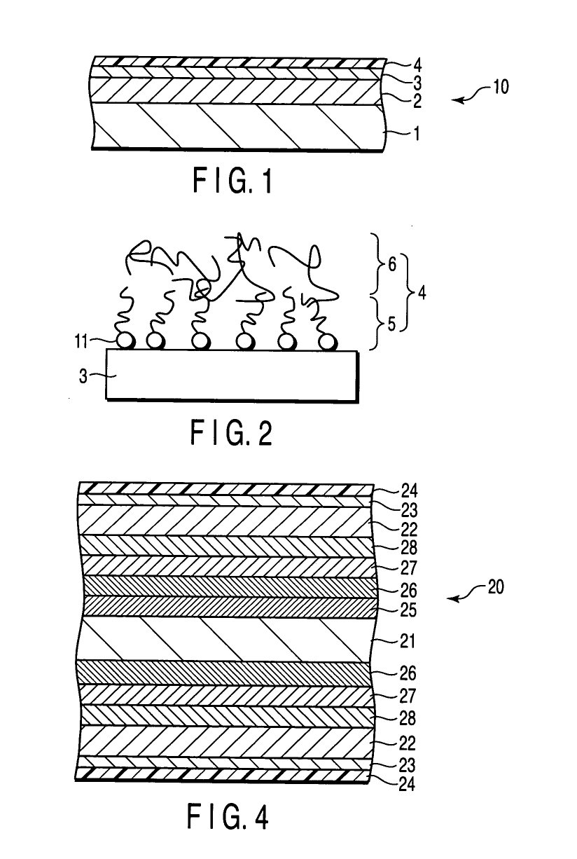

FIG. 2 is a model view showing the structure of the lubricating layer used in the present invention.

As shown in FIG. 2, the lubricating layer 4 is substantially made up of a bond layer 5 bonded to the protective layer 3 and mainly containing the second perfluoropolyether, and a mobile layer 6 formed on the bond layer 5 and mainly containing the first perfluoropolyether. Reference numeral 11 denotes a polar group of the second perfluoropolyether bonded to the protective layer.

The first perfluoropolyether used in the mobile layer and having CH₃ groups or CF₃ groups has low viscosity, and, even in a low-temperature environment, has good lubricant repair properties and does not deteriorate the sliding characteristics. Therefore, the first perfluoropolyether can reduce the frictional force of this magnetic recording medium with respect to the head for long time. On the other hand, the second perfluoropolyether used in the bond layer, bonded to the protective layer by heating, and having a polar group at least at one end does not expose the protective layer even when it undergoes sliding by the head, and can maintain a high sliding resistance of the magnetic recording medium with respect to the head for long time. In the magnetic recording medium of the present invention as described above, a high sliding resistance obtained by the bond layer and a large frictional force reducing effect obtained by the mobile layer can be achieved at the same time for long time periods even in a low-temperature environment.

In one embodiment, the first perfluoropolyether can contain an amine structure having one or more CH₃ groups or one or more CF₃ groups at the two ends, or a cyclic phosphazene structure having one or more CH₃ groups or one or more CF₃ groups at the two ends.

An example of the perfluoropolyether having one or more CH₃ groups or one or more CF₃ groups at the two ends is Fomblin Z15 (manufactured by AUSIMONT) (average molecular weight=8,000, kinematic viscosity=160 20 deg:cSt, specific gravity=1.84 20 deg:g/cm³). An example of the perfluoropolyether containing the amine structure having CH₃ groups at an end is ZDPA (manufactured by Matsumura Oil Research) (average molecular weight=4,000, kinematic viscosity=28 20 deg:cSt, specific gravity=1.65 20 deg:g/cm³).

An example of the perfluoropolyether having a polar group, e.g., an OH group at one end is Fomblin Z-Tetraol (manufactured by AUSIMONT) (average molecular weight=2,000, viscosity=2,200 20 deg:cSt, specific gravity=1.75 20 deg:g/cm³).

To increase the decomposition resistance, it is possible to further add A20H (manufactured by Matsumura Oil Research) (average molecular weight=2,000, kinematic viscosity=176 20 deg:cSt, specific gravity=1.7 20 deg:g/cm³) as the perfluoropolyether containing the cyclic phosphazene structure having a polar group.

In the lubricating layer used in one embodiment of the present invention, a bonding ratio represented by the ratio of the film thickness of the bond layer to the total film thickness of the lubricating layer can be 70% or more.

If the bond ratio is less than 70%, the amount of region not covered with the lubricant increases, and this allows easy occurrence of solid contact. As a consequence, the sliding resistance often decreases.

The bond ratio is obtained as follows. A layer of the lubricant is formed by dip coating so that the film thickness is 2.3 nm. To further increase the bond ratio, the lubricating layer is heated at 150° C. for 10 min and, if necessary, irradiated with UV for 20 sec. The thickness of the obtained lubricating layer is measured by the C—F peak absorbance by using FT-IR reflection-absorption spectroscopy. After that, the obtained lubricating layer is dipped into a fluorine-based solvent, e.g., AK225 (manufactured by Asahi Glass) or Vertrel (manufactured by DuPont), thereby washing away components not bonded to the protective layer. The thickness of the remaining layer is measured by the C—F peak absorbance by using FT-IR reflection-absorption spectroscopy. The layer removed by washing is the mobile layer, and the remaining layer is the bond layer. The bond ratio is obtained by calculating the ratio of the film thickness of the bond layer to the total film thickness of the lubricating layer.

The first and second perfluoropolyethers used in the present invention can be mixed so that the bond ratio described above is 70% or more. A mixing ratio may depend on perfluoropolyethers used.

For example, when Fomblin Z15 is used as the first perfluoropolyether, Fomblin Z-Tetraol is used as the second perfluoropolyether, and A20H is also added, the mixing ratios of Fomblin Z15, Fomblin Z-Tetraol, and A20H can be 30 wt % or less, 50 to 95 wt %, and 5 to 20 wt %, respectively.

As another example, when ZDPA is used as the first perfluoropolyether, Fomblin Z-Tetraol is used as the second perfluoropolyether, and A20H is also added, the mixing ratios of ZDPA, Fomblin Z-Tetraol, and A20H can be 30 wt % or less, 50 to 95 wt %, and 0 to 10 wt %, respectively.

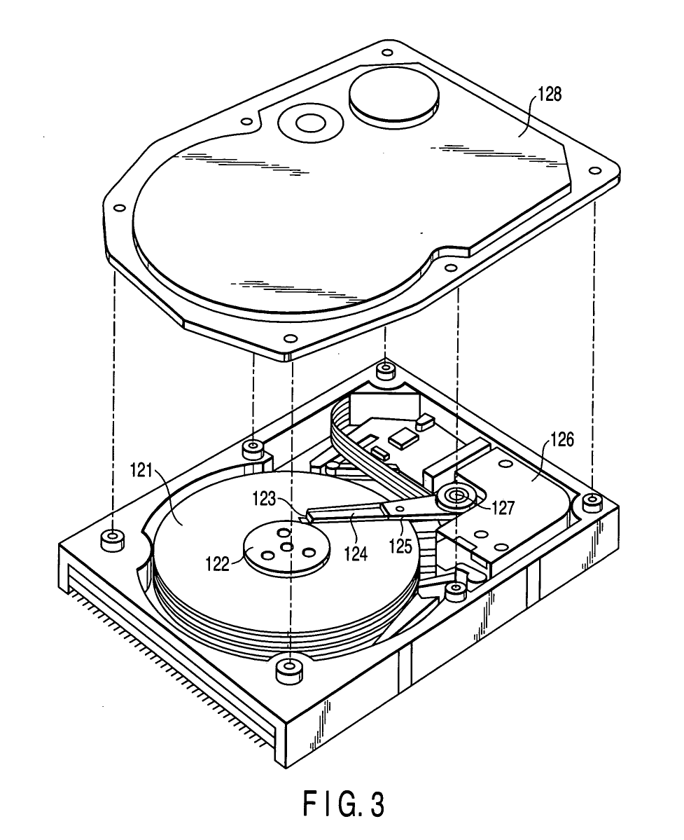

FIG. 3 is a partially exploded perspective view showing an example of the magnetic recording/reproducing apparatus according to the present invention.

A rigid magnetic disk 121 for recording information according to the present invention is fitted on a spindle 122 and rotated at a predetermined rotational speed by a spindle motor (not shown). A slider 123 mounting a recording head for accessing the magnetic disk 121 to record information and an MR head for reproducing information is attached to the distal end portion of a suspension 124 which is a thin leaf spring. The suspension 124 is connected to one end of an arm 125 having, e.g., a bobbin which holds a driving coil (not shown).

A voice coil motor 126 as a kind of a linear motor is attached to the other end of the arm 125. The voice coil motor 126 includes the driving coil (not shown) wound around the bobbin of the arm 125, and a magnetic circuit having a permanent magnet and counter yoke opposing each other so as to sandwich the driving coil between them.

The arm 125 is held by ball bearings (not shown) formed in two, upper and lower portions of a fixed shaft 127, and pivoted by the voice coil motor 126. That is, the position of the slider 123 on the magnetic disk 121 is controlled by the voice coil motor 126. Reference numeral 128 in FIG. 3 denotes a lid.

### EXAMPLES 1-4 & COMPARATIVE EXAMPLES 1-4

As substrates, 0.5-mm thick, 1.8-inch crystallized glass substrates (TS10SXL manufactured by OHARA) were prepared. The surface of each substrate was processed by polishing agent slurry containing cerium oxide such that the surface roughness was Ra=1.0 nm.

After the glass substrate surfaces were cleaned, sputtering was performed by using a sputtering apparatus (C-3010 manufactured by ANELVA) to form a first underlayer made of a Co-based alloy on the two surfaces of each substrate. In addition, the same apparatus was used to sequentially form a 10-nm thick second underlayer made of a Cr-based alloy, a 2-nm thick stabilizing layer made of a CoCrPtB alloy, a 1-nm thick intermediate layer made of Ru, a 5-nm thick recording layer made of a CoCrPtB alloy, and a 3-nm thick carbon protective layer.

After that, each carbon protective layer was coated with a 2.3-nm thick layer of a lubricant by dip coating. The lubricant was prepared by mixing Fomblin Z-Tetraol as perfluoropolyether having a high bond ratio with respect to the protective layer, A20H having a phosphazene ring, and Fomblin Z15 as perfluoropolyether terminated by a methyl group. The mixing ratio was one of the eight different mixing ratios shown in Table 1 (to be presented later). To further increase the bond ratio, each resultant material was heated at 150° C. for 10 min and irradiated with UV for 20 sec to form a lubricating layer, thereby obtaining a magnetic recording medium of the present invention. Note that a method of forming the lubricating layer is not limited to the method of mixing and applying three types of perfluoropolyethers. For example, it is also possible to first apply Fomblin Z-Tetraol and A20H, wash away components not bonded to the protective layer by using a fluorine-based solvent, heat the resultant material at 150° C. for 10 min, and then apply Fomblin Z15.

FIG. 4 is a sectional view showing the structure of each obtained magnetic recording medium.

As shown in FIG. 4, a magnetic recording medium 20 has a structure in which a first underlayer 25, second underlayer 26, stabilizing layer 27, intermediate layer 28, magnetic recording layer 22, protective layer 23, and lubricating layer 24 are sequentially formed on a substrate 21.

Measurement of Bond Ratio

The film thickness of each obtained lubricating layer was measured by the C—F peak absorbance by using FT-IR reflection-absorption spectroscopy.

After that, the medium was dipped into a solvent AK225 (manufactured by Asahi Glass) to wash away those portions of the lubricating layer, which were not fixed to the protective layer. The thickness of the remaining lubricating layer as a bond layer was measured by the C—F peak absorbance. The ratio of the thickness of the bond layer to the premeasured thickness of the lubricating layer was indicated in %. The obtained results are shown in Table 1.

Measurement of Sliding Resistance

Also, each of magnetic recording media formed following the same procedure as above was incorporated into a magnetic disk apparatus including a contact type magnetic head having a load of 2.5 gf. The head was set in a position 16.3 mm from the center of the magnetic recording medium in the radial direction, and slid at a rotational speed of 4,200 rpm. The number of days until the head crushed was measured as the sliding resistance. The obtained results are shown in Table 1.

### EXAMPLES 5 & 6 & COMPARATIVE EXAMPLE 5

Magnetic recording media were formed following the same procedure as in Example 1 except that ZDPA was used instead of Fomblin Z15, and the bond ratio and sliding resistance were measured in the same manner as in Example 1. The obtained results are shown in Table 1 below.

TABLE 1

| | | | | Sliding |
|---|---|---|---|---|
| | | | | resistance |
| | | Mixing ratio | Bond ratio | at 5° C. |
| | Lubricant | (wt %) | (%) | (days) |
| Example 1 | Z-Tetraol/A2OH/ | 80/10/10 | 75 | 12 |
| | Z15 | | | |
| Example 2 | | 66/17/17 | 72 | 9 |
| Example 3 | | 53/13/34 | 65 | 5 |
| Comparative | | 90/10/0 | 75 | 3 |
| Example 1 | | | | |
| Comparative | | 80/20/0 | 73 | 3 |
| Example 2 | | | | |
| Comparative | | 50/50/0 | 74 | 1 |
| Example 3 | | | | |
| Comparative | | 100/0/0 | 75 | 1 |
| Example 4 | | | | |
| Example 4 | | 80/0/20 | 70 | 4 |
| Example 5 | Z-Tetraol/A2OH/ | 80/0/20 | 75 | 30 or more |
| | ZDPA | | | |
| Example 6 | | 80/10/10 | 72 | 30 or more |
| Comparative | | 0/0/100 | 13 | 1 or less |
| Example 1 | | | | |

As shown in Table 1, compared to Comparative Examples 1 to 4, the sliding resistance increased in each of Examples 1 to 3 in which proper amounts of A20H having a high decomposition resistance and Z15 having good repair properties at low temperatures were mixed in Z-Tetraol having a high bond ratio. When the ratio of Z15 was high as in Example 3, the bond ratio was 70% or less, i.e., the covering properties of the bond layer were insufficient, so the sliding resistance slightly decreased. In Comparative Examples 1 to 4, the sliding resistance slightly increased when the ratio of A20H was 20 wt % or less. In Example 4 in which the ratio of A20H was 0 wt %, the sliding resistance slightly decreased because the decomposition resistance decreased.

As shown in Table 1, the sliding resistance significantly increased in Example 5 in which a proper amount of ZDPA having a high decomposition resistance and good repair properties at low temperatures was mixed in Z-Tetraol having a high bond ratio. The sliding resistance also increased when A20H was mixed as in Example 6. When neither Z-Tetraol nor A20H was contained and only ZDPA was contained as in Comparative Example 5, the bond ratio decreased, and the sliding resistance also decreased.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

1. A magnetic recording medium comprising:
a nonmagnetic substrate;
a magnetic recording layer formed on the nonmagnetic substrate;
a protective layer formed on the magnetic recording layer; and
a lubricating layer formed on the protective layer by using a lubricant containing first perfluoropolyether having not less than one CH₃ group or not less than one CF₃ group at two ends, and second perfluoropolyether having a polar group at least at one end,
wherein the lubricating layer has a bond layer which contains most of the second perfluoropolyether and is bonded to a surface of the protective layer, and a mobile layer which is formed on the bond layer, contains most of the first perfluoropolyether, and has flowability.

2. A medium according to claim 1, wherein the first perfluoropolyether contains an amine structure or cyclic phosphazene structure having a CH₃ group or CF₃ group at an end.

3. A medium according to claim 1, wherein the lubricating layer has a bond ratio of not less than 70%, the bond ratio being represented by a ratio of a film thickness of the bond layer to a total film thickness of the lubricating layer.

4. A magnetic recording/reproducing apparatus comprising:
a magnetic recording medium comprising
a nonmagnetic substrate,
a magnetic recording layer formed on the nonmagnetic substrate,
a protective layer formed on the magnetic recording layer, and
a lubricating layer formed on the protective layer by using a lubricant containing first perfluoropolyether having not less than one CH₃ group or not less than one CF₃ group at two ends, and second perfluoropolyether having a polar group at least at one end,
the lubricating layer having a bond layer which contains most of the second perfluoropolyether and is bonded to a surface of the protective layer, and a mobile layer which is formed on the bond layer, contains most of the first perfluoropolyether, and has flowability; and
a recording/reproducing head.

5. An apparatus according to claim 4, wherein the first perfluoropolyether contains an amine structure or cyclic phosphazene structure having a CH₃ group or CF₃ group at an end.

6. An apparatus according to claim 4, wherein the lubricating layer has a bond ratio of not less than 70%, the bond ratio being represented by a ratio of a film thickness of the bond layer to a total film thickness of the lubricating layer.
